(19) United States
(12) Patent Application Publication
(10) Pub. No.: US 2026/0289582 A1
(43) Pub. Date: Sep. 24, 2026

(54) METHOD AND SYSTEM FOR PERFORMING AUTOMATED AUDITS BY UTILIZING AN AUDIT FRAMEWORK

(71) Applicant: JPMorgan Chase Bank, N.A., New York, NY (US)

(72) Inventors: Smitha SUDHAKAR, Bangalore (IN); Anil Kumar MYLAVARAPU, Hyderabad (IN)

(73) Assignee: JPMorgan Chase Bank, N.A., New York, NY (US)

(21) Appl. No.: 19/201,371

(22) Filed: May 7, 2025

(30) Foreign Application Priority Data
Mar. 20, 2025 (IN) 202511025249

(51) Int. Cl. G06Q 30/018; G06F 40/134

(52) U.S. Cl. CPC G06Q 30/018; G06F 40/134

(57) ABSTRACT

A system and method for performing automated audits by utilizing an audit framework are disclosed. The method includes receiving an audit request from an entity. The method further includes collecting a set of evidences from a database within a repository, in response to the audit request. The method further includes validating the collected set of evidences in accordance with a set of predefined validation criteria. The method further includes generating an audit report using the validated set of evidences. Thereafter, the method includes providing the audit report to the entity.

### CROSS-REFERENCE TO RELATED APPLICATIONS

This application claims priority benefit from Indian Application No. 202511025249, filed on Mar. 20, 2025, in the India Patent Office, which is hereby incorporated by reference in its entirety.

### Field of the Disclosure

This technology generally relates to the field of auditing, and more particularly relates to a method and system for performing automated audits by utilizing an audit framework for performing audit reviews and reconciliation process.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In today's business and technological environments, organizations face significant challenges in managing and ensuring integrity, transparency, and accountability of their operations. Auditing plays a critical role in assessing whether an organization's processes, financial transactions, and internal controls are being properly executed and in compliance with relevant standards and laws.

Traditional auditing processes have relied on manual, paper-based systems or some software tools that lack integration of required evidences and scalability. These conventional processes or systems often require auditors to engage in time consuming tasks for preparing audits. Organizations often face difficulties when attempting to prepare audits for any products at any time. The audits, such as an office of the comptroller of the currency (OCC) audit, consumer financial protection bureau (CFPB) audit and other audits are highly important.

In existing audit frameworks, audit preparedness involves manual effort that takes a large amount of time per model/project involving review panels, compliance officer team, technology team, product team and other multiple stakeholders. Some audit systems may lack the necessary flexibility to integrate with multiple data sources, thereby leading to fragmented insights and incomplete trails. Other systems fail to provide adequate tools for real time monitoring and reporting. Hence, the organizations fail to detect issues and ensure compliance.

Hence, in light of these and other existing limitations, there arises an imperative need to provide an efficient solution to overcome the above-mentioned limitations and to provide a method and system that can perform more efficient, comprehensive, and proactive automated audits.

### SUMMARY

The present disclosure, through one or more of its various aspects, embodiments, and/or specific features or sub-components, provides, inter alias, various systems, servers, devices, methods, media, programs, and platforms for performing automated audits utilizing an audit framework.

According to an aspect of the present disclosure, a method for performing automated audits utilizing an audit framework is disclosed. The method is implemented by at least one processor. The method includes receiving, with the at least one processor, an input from an entity for an audit request. The method also include collecting, by the at least one processor, a set of evidences from a database stored within a repository in response to the audit request. The method also includes validating, by the at least one processor, the collected set of evidences in accordance with a set of predefined validation criteria. The method also includes generating, by the at least one processor, an audit report using the validated set of evidence. Finally, the method includes providing, by the at least one processor, the audit report to the entity.

In accordance with an exemplary embodiment, the input may include at least one among: a functional identifier (FID), a project name, and a model name.

In accordance with an exemplary embodiment, the audit report may include at least one from among: the set of evidences along with corresponding paths, a status of each evidence, and governance control names.

In accordance with an exemplary embodiment, the set of evidences stored in the database may be received from a plurality of sources.

In accordance with an exemplary embodiment, each evidence from the set of evidences may be validated prior to storing in the database, wherein each evidence from the set of evidences may be validated in accordance with a set of predefined validation criteria.

In accordance with an exemplary embodiment, the set of predefined validation criteria may include a plurality of model delivery controls.

In accordance with an exemplary embodiment, the set of evidences in the audit report may be hyperlinked to enable downloading the set of evidences from the database.

According to another aspect of the present disclosure, a computing device configured to perform automated audits utilizing an audit framework is disclosed. The computing device includes a processor; a memory storing instructions; and a communication interface coupled to each of the processor and the memory. The processor may programmed to cooperate with the instructions to perform operations including: receive an input from an entity for an audit request; collect a set of evidences from a database stored within a repository in response to the audit request; validate the collected set of evidences in accordance with a set of predefined validation criteria; generate an audit report using the validated set of evidences; and provide the audit report to the entity.

In accordance with an exemplary embodiment, the input may include at least one from among: a functional identifier (FID), a project name, and a model name.

In accordance with an exemplary embodiment, the audit report may include at least one from among: the set of evidences along with paths, a status of each evidence, and governance control names. In accordance with an exemplary embodiment, the set of evidences stored in the database is received from a plurality of sources.

In accordance with an exemplary embodiment, each evidence from the set of evidences may be validated prior to storing in the database, wherein each evidence from the set of evidences may be validated in accordance with a set of predefined validation criteria.

In accordance with an exemplary embodiment, the set of predefined validation criteria may include a plurality of model delivery controls.

In accordance with an exemplary embodiment, the set of evidences in the audit report may be hyperlinked to enable downloading the set of evidences from the database.

According to yet another aspect of the present disclosure, a non-transitory computer-readable storage medium storing instructions to perform automated audits utilizing an audit framework is disclosed. The instructions include executable code which, when executed by a processor, may cause the processor to perform operations including: receive an input from an entity for an audit request; collect a set of evidences from a database stored within a repository in response to the audit request; validate the collected set of evidences in accordance with a set of predefined validation criteria; generate an audit report using the validated set of evidences; and provide the audit report to the entity.

In accordance with an exemplary embodiment, the input may include at least one among: a functional identifier (FID), a project name, and a model name.

In accordance with an exemplary embodiment, the audit report may include at least one from among: the set of evidences along with paths, a status of each evidence, and governance control names.

In accordance with an exemplary embodiment, the set of evidences stored in the database may be received from a plurality of sources.

In accordance with an exemplary embodiment, each evidence from the set of evidences may be validated prior to storing in the database, wherein each evidence from the set of evidences may be validated in accordance with a set of predefined validation criteria.

In accordance with an exemplary embodiment, the set of predefined validation criteria may include a plurality of model delivery controls.

In accordance with an exemplary embodiment, the set of evidences in the audit report may be hyperlinked to enable downloading the set of evidences from the database.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for performing automated audits by utilizing an audit framework, in accordance with an exemplary embodiment of the present disclosure.

FIG. 2 illustrates an exemplary diagram of a network environment for performing automated audits by utilizing an audit framework, in accordance with an exemplary embodiment of the present disclosure.

FIG. 3 illustrates a system diagram for performing automated audits by utilizing an audit framework, in accordance with an exemplary embodiment of the present disclosure.

FIG. 4 illustrates an exemplary method flow diagram for performing automated audits by utilizing an audit framework, in accordance with an exemplary embodiment of the present disclosure.

FIG. 5 illustrates a block diagram representing a system for performing automated audits by utilizing an audit framework, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

In existing audit frameworks, audit preparedness involves manual efforts that take large amount of time per model/project involving review panels, compliance officer team, technology team, product team and multiple stakeholders. Some existing audit systems may lack the necessary flexibility to integrate with multiple data sources, thereby leading to fragmented insights and incomplete trails. Other systems fail to provide adequate tools for real time monitoring and reporting. Hence organizations utilizing the existing audit systems fail to detect issues related to auditing and also fail to ensure compliance in a timely manner. In today's business landscape, audits have become essential to help organizations steer complex operations. Audits ensure transparency, accountability, and compliance within business processes. Many businesses are tasked with adhering to numerous frameworks, resulting in the necessity to conduct more than one audit and/or assessment each year. Given the complexity of these frameworks, preparation for audits is a time-consuming effort, and even results in duplicate efforts across multiple audits. Organizations that have multiple teams or departments might also inadvertently gather the same evidence repeatedly to be used at various points in time. Additionally, the existing frameworks fail to provide adequate tools for detecting the issues in real-time and ensuring compliance in a timely manner. Due to these complexities, many organizations find it difficult to allocate the correct resources to navigate different frameworks and complete all the required assessments in a timely, accurate manner.

To overcome the above-mentioned problems, the present disclosure provides a method and system for performing automated audits by utilizing an audit framework. In the present disclosure, the system receives an audit request from an entity. The system further collects a set of evidences from a database stored within a repository in response to the audit request. The system also validates the collected set of evidences in accordance with a set of predefined validation criteria. The system further generates an audit report using the validated set of evidences. Thereafter, the system provides the audit report to the entity.

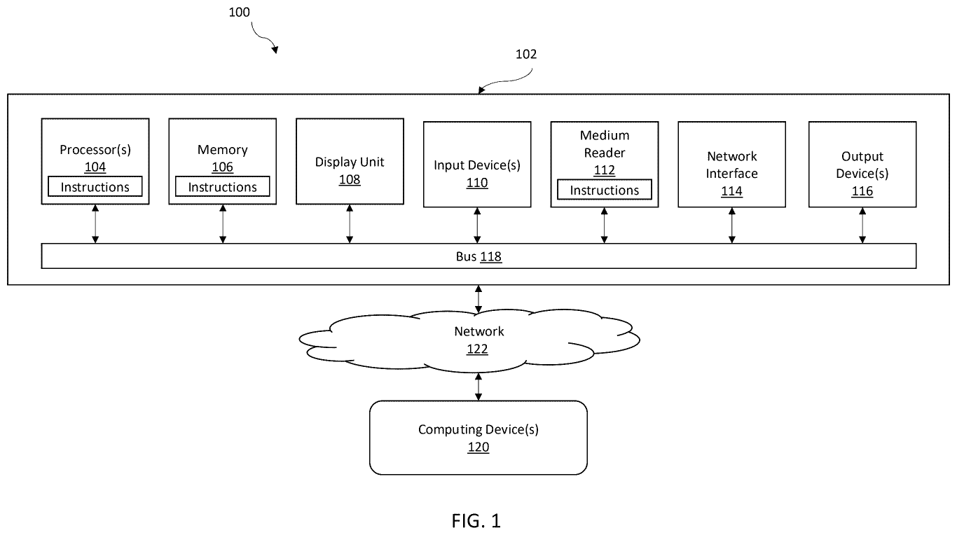

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such cloud-based computing environment.

In a networked deployment, the computer system 102 may operate in the capacity of a server or as a client-user computer in a server-client network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article about manufacturing and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may be constructed to implement one or more of the methods or functionalities as described herein, and a processor 104 described herein may be used to support a virtual processing environment.

As described herein, various embodiments provide methods and systems for performing automated audits by utilizing an audit framework.

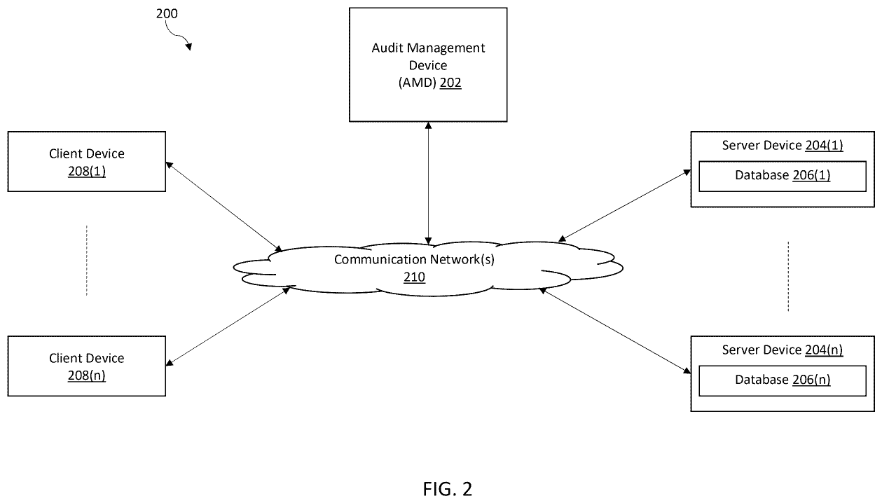

Referring to FIG. 2, a schematic of an exemplary network environment 200 for performing automated audits by utilizing an audit framework is illustrated. In an exemplary implementation, the method is executable on any networked computer platform, such as, for example, a personal computer (PC).

The method for performing automated audits by utilizing an audit framework may be executed by an audit management device (AMD) 202. The AMD 202 may be the same or similar to the computer system 102 as described with respect to FIG. 1. The AMD 202 may store one or more applications that may include executable instructions that, when executed by the AMD 202, cause the AMD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the AMD 202 itself, may be located in the virtual server(s) running in a cloud-based computing environment rather than being tied to one or more specific physical network computing devices. Also, the application(s) may be running in one or more virtual machines (VMs) executing on the AMD 202. Additionally, in one or more embodiments of this technology, virtual machine(s) running on the AMD 202 may be managed or supervised by a hypervisor.

In the network environment 200 of FIG. 2, the AMD 202 is coupled to a plurality of server devices 204(1)-204(n) that host a plurality of databases 206(1)-206(n), and also to a plurality of client devices 208(1)-208(n) via communication network(s) 210. A communication interface of the AMD 202, such as the network interface 114 of the computer system 102 of FIG. 1, operatively couples and communicates between the AMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and AMDs that efficiently implement the method for performing automated audits by utilizing an audit framework.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The AMD 202 may be a standalone device or integrated with one or more other devices or apparatuses, such as one or more of the server devices 204(1)-204(n), for example. In one particular example, the AMD 202 may include or be hosted by one of the server devices 204(1)-204(n), and other arrangements are also possible. Moreover, one or more of the devices of the AMD 202 may be in a same or a different communication network including one or more public, private, or cloud-based networks, for example.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the AMD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store connection requests, connection data associated with the connection requests, a plurality of proxy rules, validation rules, predefined criteria and information about applications (e.g., on-prem applications) associated with at least one cloud service platform, for implementation of the features of the present disclosure.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the AMD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at least one client device 208 is a wireless mobile communication device, e.g., a smartphone.

The client devices 208(1)-208(n) may run interface applications, such as standard web browsers or standalone client applications, which may provide an interface to communicate with the AMD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the AMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AMD 202, the server devices 204(1)-204(n), or the client devices 208(1)-208(n), for example, may be configured to operate as virtual instances on the same physical machine. In other words, one or more of the AMD 202, the server devices 204(1)-204(n), or the client devices 208(1)-208(n) may operate on the same physical device rather than as separate devices communicating through communication network(s) 210. Additionally, there may be more or fewer AMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

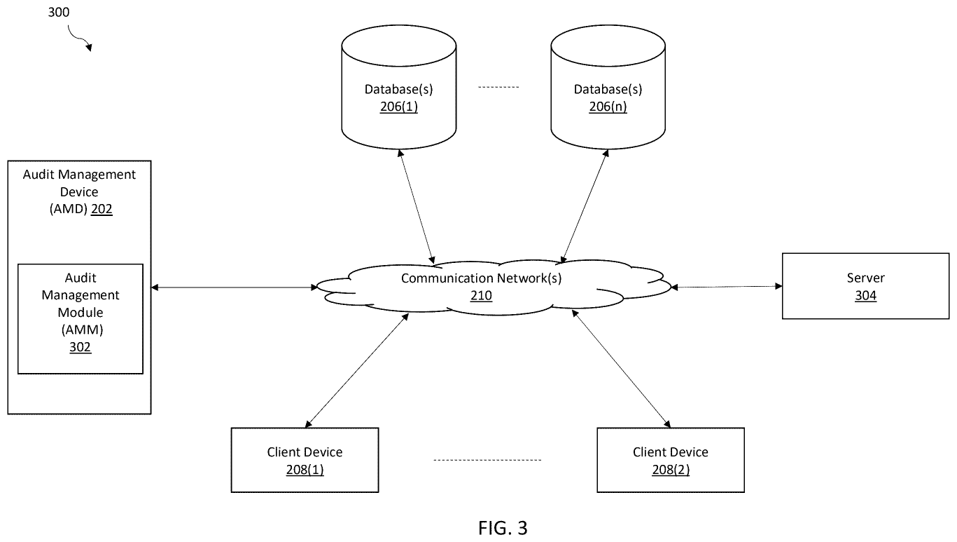

FIG. 3 illustrates a system diagram for performing automated audits by utilizing an audit framework, in accordance with an exemplary embodiment.

As illustrated in FIG. 3, the system 300 may include an audit management device (AMD) 202 within which an audit management module (AMM) 302 is embedded, a server 304, a database(s) 206(1) . . . 206(n), a plurality of client devices 208(1) . . . 208(2), and a communication network(s) 210.

According to exemplary embodiments, the system 300 may comprise the AMD 202 including the AMM 302 which may be connected to the server 304 and the database(s) 206(1) . . . 206(n) via the communication network(s) 210, but the disclosure is not limited thereto. The AMD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the AMD 202 as described and shown in FIG. 3 includes the AMM 302, although it may include other rules, policies, modules, databases, or applications, for example. As will be described below, the AMM 302 is configured to carry out a method for performing automated audits utilizing an audit framework.

An exemplary system 300 for enabling a mechanism for performing automated audits by utilizing an audit framework in the network environment of FIG. 2 is shown as being executed in FIG. 3. Specifically, a first client device 208(1) and a second client device 208(2) are illustrated as being in communication with AMD 202. In this regard, the first client device 208(1) and the second client device 208(2) may be “clients” of the AMD 202 and are described herein as such. Nevertheless, it is to be known and understood that the first client device 208(1) and/or the second client device 208(2) need not necessarily be “clients” of the AMD 202, or any entity described in association therewith. Any additional or alternative relationship may exist between either or both of the first client device 208(1) and the second client device 208(2) and the AMD 202, or no relationship may exist.

Further, the AMD 202 is illustrated as being able to access one or more database(s) 206(1) . . . 206(n). The AMM 302 may be configured to access these repositories/databases to provide a method for performing automated audits utilizing an audit framework. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the AMD 202 via broadband or cellular communication. These embodiments are merely exemplary and are not limiting or exhaustive.

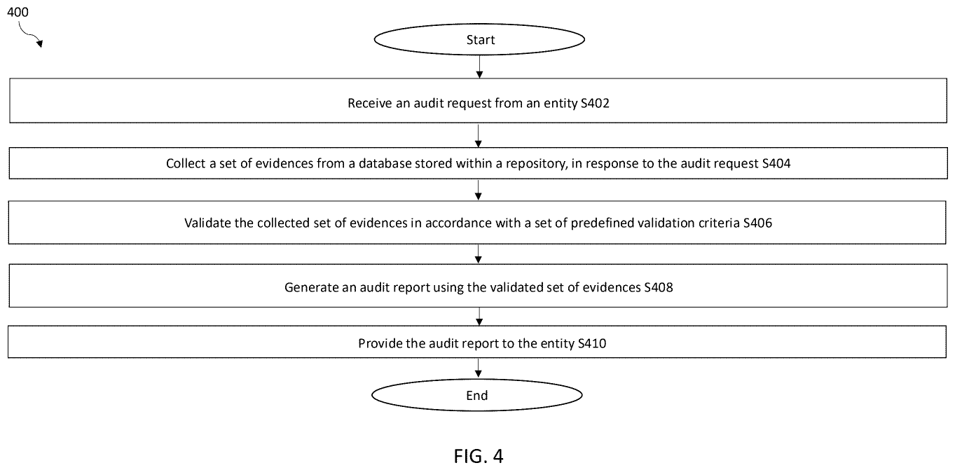

Referring to FIG. 4, an exemplary method 400 is shown for performing automated audits by utilizing an audit framework, in accordance with an exemplary implementation.

The method begins when a user or an entity wants to prepare an audit report for at least one area or product across an organization at anytime, anywhere. The method 400 is implemented by at least one processor 104. The user may be an individual (e.g., an admin or an administrator) who interacts with a portal to raise a request for preparing an audit.

At step S402, the method includes receiving, by the at least one processor 104, an audit request from an entity. In an embodiment, the audit request may include at least one from among: a functional identifier (FID), a project name, and a model name (e.g., a model or project deliverable).

In an exemplary implementation, the audit request may be received with the parameters such as the FID: G56909, the project name: credit risk modeling (consumer and community banking (CCB) risk), and the model name: customer centric long term risk model (CCLTR: 56008).

In an exemplary embodiment, the entity may include at least one from among: an auditor or an administrator which provides the input over a platform (e.g., an application or a web executable interface). In an example, the entity may provide the audit request over a portal, or a user interface (UI) associated with a cloud computing platform.

As used herein, the term “audit” refers to a formal examination or review of an organization's financial records, operations, compliance with regulations, or performance to ensure accuracy, transparency, and adherence to required standards or laws.

At step S404, the method includes collecting, by the at least one processor 104, a set of evidences from a database stored within a repository (e.g., an evidence store) in response to the input. In an exemplary embodiment, the set of evidences may include at least one from among: a data mapping document, a data usage code evidence, a high level design and an approved plan (e.g., sprint plan), an approved test strategy, an exit criteria report, an integrated model code, a pre-production sign off, a model onboarding checking list, go approval, no-go approval, post production validation, post production validation sign-off, and downstream consumption confirmation. In an embodiment, the set of evidences stored in the database is received from a plurality of sources.

In an exemplary implementation, the plurality of sources may include at least one from among: internal systems and external systems. In an embodiment, the plurality of sources may include but is not limited to, an account owner profile, a project management tool, an issue tracking tool, and file managers. The repository (e.g., an evidence store) acts as a central repository, consolidating and storing a set of evidences collated from the plurality of sources.

In an exemplary implementation, each evidence from the set of evidences may be validated prior to storing in the database, wherein each evidence from the set of evidences may be validated in accordance with a set of predefined validation criteria. It is to be noted that each evidence may be validated to ensure its authenticity and relevance. In an embodiment, the set of predefined validation criteria may include a plurality of model delivery controls. In an embodiment, the model delivery controls may include firmwide or area product level controls. For example, in every phase of a model journey or a product delivery, a delivery manager who acts as the admin has a responsibility of taking care of product toll gate validation process. It is to be noted that the firmwide or area product level controls for every execution step of the model/product delivery are taken as benchmark for validation.

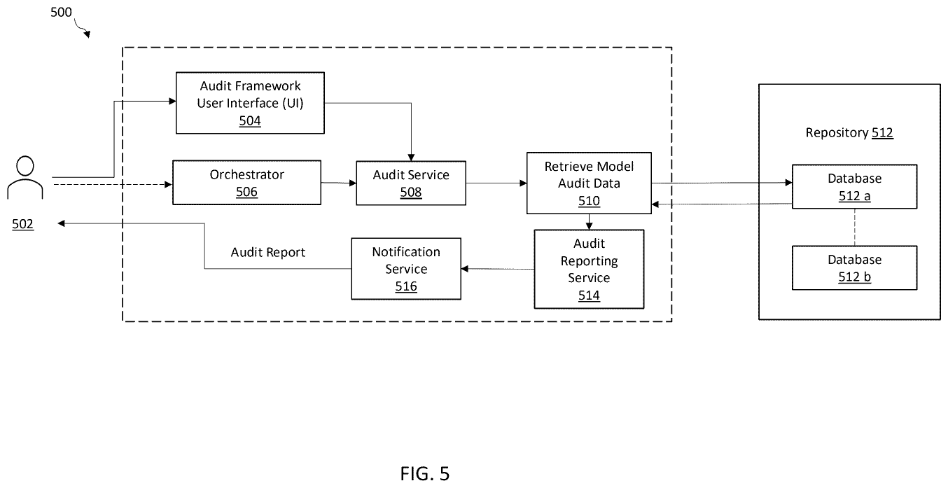

At step S406, the method includes validating, by the at least one processor 104, the collected set of evidences in accordance with a set of predefined validation criteria. In an embodiment, the set of predefined criteria may include a plurality of execution steps to validate the set of evidences received from the plurality of sources. The execution steps are further described in details with respect to FIG. 5 in subsequent paragraphs.

In an exemplary embodiment, the set of predefined criteria refers to a predefined set of rules, standards, or guidelines that are used to assess whether the collected evidence meets the required standards of validity, accuracy, and compliance. For example, area product level controls may include a pre-defined set of rules and standards to validate the authenticity of a content. Any tampered or irrelevant content that does not comply with the set of rules is not authorized to be saved in the evidence store. This reduces the amount of computer storage used, as there is no need to store non-validated information. It also reduces the amount of electrical power consumed by the process, both in savings of electrical power for storage as well as savings in electrical power from the subsequent processing of only validated data rather than all data.

The method further includes transferring, by the at least one processor 104, the set of evidences in a standardized format via an interface (e.g., an application programming interface (API)) from the database (which is authorized system of record) using a predefined communication protocol (such as hypertext transfer protocol (HTTP), file transfer protocol (FTP), or custom protocols). In an embodiment, the set of evidences may be transferred in a standardized format, ensuring that the set of evidences is compatible with other systems or services.

For example, after the set of evidences has been validated, the method continues by transferring the validated set of evidences to a designated location for preparing an audit report. The designated location may be a centralized server or a secondary database. The designated location may be different from the locations in which prior steps were preformed, which prevents contamination at the designated location between pre-validated information (which the designated location never received) and validated information.

At step S408, the method includes generating, by the at least one processor 104, an audit report using the validated set of evidences. In an embodiment, the audit report may include at least one from among: the set of evidences along with corresponding paths (e.g., hyperlinks of evidences), a status of each evidence (e.g., status of audit readiness for each job), and governance control names (e.g., business justification, monitoring, tech feasibility assessment, etc.).

At step S410, the method includes providing, by the at least one processor 104, the audit report to the entity.

For example, if the entity is an administrator, then the audit report is sent to the administrator in at least one file format. The at least one file format may be a Microsoft® word or portable document format (PDF). In an embodiment, the audit report may be sent to the administrator via a notification service. In an exemplary implementation, the set of evidences in the audit report may be hyperlinked to enable downloading the set of evidences directly from the database or the evidence store. In this way the audit report is prepared in an automated manner and provided to the entity who requested the audit report. The automated framework as described enables collection of evidences integrated with the evidence store, thereby reducing audit preparation time. Further, based on an audit schedule, an audit report per model may be generated that categorically summarizes the audit readiness based on governance controls and shared with the business users for initiating timely actions.

This way the method disclosed in the present disclosure ensures automated creation of audit reports by using the audit framework.

FIG. 5 illustrates a process flow 500 for performing automated audits by utilizing an audit framework, in accordance with an exemplary embodiment. As illustrated in FIG. 5, the process flow 500 begins with receiving, by at least one processor 104, an audit request from an entity 502 through an application or a web executable interface of a platform. In an exemplary implementation, the entity 502 may include at least one from among: an auditor or an administrator which provides the audit request over the platform. In an example, the entity 502 may provide the audit request over a portal or a user interface (UI) of an audit framework 504. In an embodiment, the audit framework may be associated with a cloud computing platform (e.g., amazon web service (AWS®)).

As used herein, “entity” may refer to an individual auditor or a system acting on behalf of the auditor to carry out the validation process that has its own distinct identity within an organization.

In an exemplary implementation, the entity 502 may transmit the audit request to an orchestrator 506 through an orchestrator batch job, thereby invoking the audit service 508 to prepare an audit report.

Further, upon receipt by the audit framework user interface (UI) 504, the audit service 508 is triggered by the audit framework UI 504. Subsequently, the audit service 508 retrieves a set of evidences by accessing toll gate milestones (specific checkpoints or decision points in a project) from a repository/database 512a/512b stored within a repository 512 (e.g., an evidence store) in response to the audit request. In an exemplary implementation, the set of evidences may be captured in the database 512a which serves as an authorized system of record. The set of evidences stored in the database 512a may be received from a plurality of sources. In an exemplary implementation, each evidence from the set of evidences may be validated prior to being stored in the database 512a. As noted above, prior validation of the evidence reduces computer storage and consumption of electrical power.

Each evidence from the set of evidences may be validated in accordance with a set of predefined validation criteria. In an embodiment, the set of predefined validation criteria may include a plurality of model delivery controls (e.g., firmwide or area product level controls).

In an exemplary implementation, a model delivery manager may validate the set of evidences in accordance with a set of predefined validation criteria. The validation process may be performed at the tollgate milestones by the model delivery manager and is explained as follows: In the first step, for every model as mentioned in the received audit request, an initial analysis of requirement is conducted, including data source analysis. Deliverable artifacts for the first step will be the evidences captured in the form of a plan with high-level estimates and finalized testing strategy.

In a second step, code analysis and design are executed in accordance with the model requirements. The deliverable artifacts for the second step are the evidences from data mapping documents and a high level design and sprint plan. In a third step, code implementation is performed as part of this execution step. The deliverable artifacts for the third step are the evidences collated by testing exit criteria report.

In a fourth step, end-to-end model integration is executed. The deliverable artifacts for the fourth execution step may include the integrated model code. In a fifth step, end-to-end model pre-production deployment is conducted, deploying all modules associated with the model. The deliverable artifacts for the fifth step may include pre-production sign-off, model on-boarding checklist, go approval, and no-go approval. In the sixth step, the fully integrated and approved model code is deployed into production, initially disabling the consumption of model output scores. The deliverable artifacts for the sixth execution step may include the model code deployed into the production, available for post-production validation. In the seventh step, the deliverable artifacts may include post-production validation sign-off. Finally, the model scores are enabled for consumption within the production environment, facilitating the continuation of standard model (e.g., business-as-usual) operations. The deliverable artifact for this execution step is the confirmation of downstream consumption.

Further, the audit service 508 may be configured to generate the audit report utilizing the validated set of evidences. Thereafter, a notification service 516 may receive the audit report from an audit reporting service 514. The notification service 516 may send the audit report to the entity 502 in at least one format. In an exemplary implementation, the at least one format may be a Microsoft® Word or portable document format (PDF).

In an exemplary implementation, a validation process for evidences is explained as follows: At first, in response to the audit request, the audit service applies firmwide/area product level controls for each execution step of the model or product delivery to validate each evidence. Once the validation process is successful, authentic evidence relevant to the model pertaining to the appropriate execution step is stored within the repository 512 (e.g., an evidence store). The authenticity of the evidence is preserved at every execution step through this validation process. It should be noted that any of the tampered or irrelevant content that does not comply with the firmwide or area product level controls is not authorized for storage in the evidence store. For example, data usage code approval is required before initiating third execution step, ‘code implementation,’ of the product, as mandated by the firmwide or area product level controls.

In this manner, the process flow 500 performs automated audits by utilizing the audit framework.

Each of blocks 504, 508, 508, 510, 512, 514, and 516, may be performed by distinct modules, each with its own distinct main processor, and each module may have backup/redundant processors to utilize in case of failure of the main processor of any module. The distribution of functionalities to different modules/processors with backups limits the impact on the overall process from failure of any individual processor.

It will be appreciated by the person skilled in the art that the system offers a full-circle, adaptable, and intelligent solution for implementing a method for performing automated generation of audit reports.

The present disclosure provides several advantages as given below. The disclosed method provides automated mechanisms for managing and validating evidences from a plurality of sources. Hence reducing the need for manual auditing and ensuring that audits are conducted in a consistent manner without human error. The disclosed method helps in saving time for various teams by providing automated audit reports. The disclosed method helps in collating the evidences integrated with an evidence store reducing the hassle of audit preparation involving manual efforts that takes large amount of time per model/product involving product, modeling, compliance officer, review panel and other stake holders, etc. The disclosed audit framework improves accuracy and efficiency in providing responses to user reviews in a timely manner.

The disclosed method enables every area product across the firm to be audit ready anytime, anywhere, proactively without waiting for audit schedules for the year. The disclosed method ensures generation of audit report per model summarizing the audit readiness based on governance controls and shared with the review panel in a timely manner. Monetary and Reputation loss caused by the OCC Audit, CFPB Audit and other audit fines may be avoided by implementing the audit framework as disclosed by the present disclosure. Manual hours spent in the audit preparation are reduced effectively by automating review process of evidences per model.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for performing automated audits by utilizing an audit framework is disclosed. The instructions include executable code which, when executed by a processor 104, may cause the processor 104 to receive an audit request from an entity; collect a set of evidences from a database stored within a repository in response to the audit request; validate the collected set of evidences in accordance with a set of predefined validation criteria; generate an audit report using the validated set of evidences; and provide the audit report to the entity.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skilled in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method for performing automated audits by utilizing an audit framework, the method being implemented by at least one processor, the method comprising:
receiving, by the at least one processor, an audit request from an entity;
collecting, by the at least one processor, a set of evidences from a database stored within a repository, in response to the audit request;
validating, by the at least one processor, the collected set of evidences in accordance with a set of predefined validation criteria;
generating, by the at least one processor, an audit report using the validated set of evidences, wherein the audit report comprises the set of evidences along with corresponding paths, a status corresponding to each evidence from the set of evidences, and governance control names, and wherein the set of evidences in the audit report are hyperlinked to enable downloading the set of evidences from the database; and
providing, by the at least one processor, the audit report to the entity.

2. The method as claimed in claim 1, wherein the audit request comprises at least one from among: a functional identifier (FID), a project name, and a model name.

3. (canceled)

4. The method as claimed in claim 1, wherein the set of evidences stored in the database is received from a plurality of sources.

5. The method as claimed in claim 1, wherein each evidence from the set of evidences is validated prior to storing in the database, wherein each evidence from the set of evidences is validated in accordance with the set of predefined validation criteria.

6. The method as claimed in claim 5, wherein the set of predefined validation criteria comprises a plurality of model delivery controls.

7. (canceled)

8. A computing device configured for performing automated audits by utilizing an audit framework, the computing device comprising:
a processor;
a memory storing instructions; and
a communication interface coupled to each of the processor and the memory, wherein the processor is programmed to cooperate with the instructions to perform operations comprising:
receive an audit request from an entity;
collect, a set of evidences from a database stored within a repository, in response to the audit request;
validate the collected set of evidences in accordance with a set of predefined validation criteria;
generate an audit report using the validated set of evidences, wherein the audit report comprises the set of evidences along with corresponding paths, a status corresponding to each evidence from the set of evidences, and governance control names, and wherein the set of evidences in the audit report are hyperlinked to enable downloading the set of evidences from the database; and
provide the audit report to the entity.

9. The computing device as claimed in claim 8, wherein the audit request comprises at least one among: a functional identifier (FID), a project name, and a model name.

10. (canceled)

11. The computing device as claimed in claim 8, wherein the set of evidences stored in the database is received from a plurality of sources.

12. The computing device as claimed in claim 8, wherein each evidence from the set of evidences is validated prior to storing in the database, wherein each evidence from the set of evidences is validated in accordance with the set of predefined validation criteria.

13. The computing device as claimed in claim 12, the set of predefined validation criteria comprises a plurality of model delivery controls.

14. (canceled)

15. A non-transitory computer readable storage medium storing instructions for performing automated audits by utilizing an audit framework, the instructions comprising executable code which when executed by a processor, causes the processor to perform operations comprising:
receive an audit request from an entity;
collect, a set of evidences from a database stored within a repository, in response to the audit request;
validate the collected set of evidences in accordance with a set of predefined validation criteria;
generate an audit report using the validated set of evidences, wherein the audit report comprises the set of evidences along with corresponding paths, a status corresponding to each evidence from the set of evidences, and governance control names, and wherein the set of evidences in the audit report are hyperlinked to enable downloading the set of evidences from the database; and
provide the audit report to the entity.

16. The storage medium as claimed in claim 15, wherein the audit request comprises at least one among: a functional identifier (FID), a project name, and a model name.

17. (canceled)

18. The storage medium as claimed in claim 15, wherein the set of evidences stored in the database is received from a plurality of sources.

19. The storage medium as claimed in claim 15, wherein each evidence from the set of evidences is validated prior to storing in the database, wherein each evidence from the set of evidences is validated in accordance with the set of predefined validation criteria.

20. The storage medium as claimed in claim 15, the set of predefined validation criteria comprises a plurality of model delivery controls.

21. The method as claimed in claim 1, wherein the validating of the collected set of evidences, comprises:
executing code analysis and design in accordance with model requirements.

22. The method as claimed in claim 21, wherein the validating of the collected set of evidences, comprises:
executing end-to-end model integration to deliver integrated model code; and
deploying the integrated model code.

23. The computing device as claimed in claim 12, wherein the validating of the collected set of evidences, comprises:
executing code analysis and design in accordance with model requirements.

24. The computing device as claimed in claim 23, wherein the validating of the collected set of evidences, comprises:
executing end-to-end model integration to deliver integrated model code; and
deploying the integrated model code.

25. The storage medium as claimed in claim 15, wherein the validating of the collected set of evidences, comprises at least one from among:
executing code analysis and design in accordance with model requirements;
executing end-to-end model integration to deliver integrated model code; and
deploying the integrated model code.
